(19) United States
(12) Patent Application Publication
(10) Pub. No.: US 2006/0291509 A1
(43) Pub. Date: Dec. 28, 2006

(54) Apparatus for illuminating a surface

(76) Inventors: Thomas Mitra, Dortmund (DE); Jens Meinschien, Dortmund (DE); Wieland Hill, Dortmund (DE)

Correspondence Address: HOFFMAN, WASSON & GITLER, P.C., 2461 South Clark Street, Suite 522, Crystal Center 2, Arlington, VA, 22202, US

(21) Appl. No.: 11/179,821

(22) Filed: Jul. 13, 2005

(30) Foreign Application Priority Data
Jul. 14, 2004 (DE) 10 2004 034 253.9

(51) Int. Cl. H01S 3/10

(52) U.S. Cl. 372/25

(57) ABSTRACT

Apparatus for illuminating a surface, having at least one semiconductor laser bar with a plurality of emitters in the case of which the spacing of the individual emitters from one another is smaller than the extent of the emitters in the first direction (X), beam transforming means for transforming the laser light emerging from the emitters that are designed in such a way that they can exchange the divergence of the laser light with regard to the first direction (X) with the divergence with regard to the second direction (Y), the beam transforming means having such a spacing from the laser diode bar that at least the laser light from two directly adjacent emitters overlaps with one another upon impinging on the beam transforming means in the first direction (X).

### BACKGROUND OF THE INVENTION

The present invention relates to an apparatus for illuminating a surface, having at least one semiconductor laser bar with a plurality of emitters that are arranged in a first direction next to one another and at a spacing from one another, the spacing of the individual emitters from one another being smaller than the extent of the emitters in the first direction, and the divergence of the laser light emerging from the individual emitters being smaller with regard to the first direction than the divergence of laser light with regard to a second direction perpendicular to the first direction, as well as also comprising collimation means for the at least partial collimation of the laser light emerging from the emitters.

Apparatuses of the abovenamed type are sufficiently known. Semiconductor laser bars with a very small spacing between the individual emitters are generally designed as QCW bars that can be operated in a quasi-continuous fashion. In the case of semiconductor laser bars and also of QCW bars, the divergence in the so-called fast axis, that is to say in the second direction, or direction perpendicular to the direction in which the emitters are arranged next to one another, is clearly greater than in the so-called slow axis or the first direction. Nevertheless, the laser light emerging from the semiconductor laser bar is more difficult to collimate with regard to the slow-axis direction because, firstly, the emitters are extended in this slow-axis direction and, secondly, because a complete row of emitters is arranged next to one another. Consequently, in the case of semiconductor laser bars that are not designed as QCW bars, and thus in the case of which the spacing of the individual emitters from one another is generally greater than the extent of the emitters in the slow-axis direction, beam transforming means are introduced into the beam path before the collimation of the slow axis. These beam transforming means disclosed, for example, in EP 1 006 382 B1 can rotate the laser light, or can exchange the divergence of the laser light with regard to the first, or the slow-axis, direction with the divergence with regard to the second, or the fast-axis, direction. Furthermore, these beam transforming beams are arranged near the semiconductor laser bars in such a way that, before entry into the beam transforming means, the light from individual emitters does not yet overlap with one another. This produces a possibility for arranging slow-axis collimation means at a relatively large spacing from the semiconductor laser bars such that a large beam extent is achieved in the slow-axis direction that in turn permits a small divergence in the slow-axis direction and also a good collimatability. Such arrangements have not yet been implemented in the case of QCW bars, and so the collimatability of the laser light emanating from QCW bars is very poor.

Furthermore, in the case of the use of a semiconductor laser bar for illuminating a surface or for operating a free emitter, the different divergence of fast axis and slow axis and/or the poor collimatability of the slow axis turn out to be disadvantageous.

One problem on which the present invention is based is to provide an apparatus of the type mentioned in the beginning that can be used more effectively for illuminating a surface.

### SUMMARY OF THE INVENTION

It is provided that for the purpose of transforming the laser light emerging from the emitters the illuminating apparatus has beam transforming means that are designed, and arranged in the beam path of the laser light emerging from the emitters, in such a way that they can exchange the divergence of the laser light with regard to the first direction with the divergence with regard to the second direction, the beam transforming means having such a spacing from the laser diode bar that at least the laser light from two directly adjacent emitters overlaps with one another upon impinging on the beam transforming means in the first direction.

It has surprisingly been shown that despite the overlapping of the laser light of adjacent emitters only comparatively slight losses occur before the impingement on the beam transforming means when using beam transforming means in the case of semiconductor laser bars with a short spacing between the individual emitters, that is to say in the case of QCW bars, for example. The losses occurring in the beam transforming means owing to the prior overlapping are, for example, less than 5%. The collimatability, and thus the ability to be used as a free emitter or for illuminating a surface can thereby be substantially improved owing to the use, which is surprisingly possible in this way, of beam transforming means, even for QCW bars.

It can be provided that the illuminating apparatus comprises homogenizer means for homogenizing the laser light emerging from the emitters. Owing to the use of homogenizer means, the homogeneity and thus the beam quality can be substantially improved such that a surface far removed from the apparatus can be illuminated very uniformly.

The uniform illumination of a surface far removed from the apparatus can be applied in multifarious ways. Examples are glare-free night vision systems in road traffic and rail traffic, as well as, in the field of metrology, digital image acquisition for production control of packaging such as, for example, foodstuffs packaging. A range of advantages result from the uniform illumination of the surface and from the better collimatability owing to the apparatus according to the invention. The intensity distribution in the region of the illuminated surface has very steep edges, and so it is possible to achieve a higher intensity in the illuminated region, because only a very slight power loss occurs in the adjacent regions. It is possible in this way to reduce the power consumption of the illuminated system, or to reduce the number of emitters or semiconductor laser bars. Furthermore, the more homogeneous intensity distribution leads to a better image contrast and permits the use of cameras that are more cost-effective in the case of digital image acquisition, for example.

It can be provided that the homogenizer means are of multistage design. It can be provided here in particular, that the number of stages of the homogenizer means for homogenizing with regard to the first direction is greater than that for homogenizing with regard to the second direction. Since the laser light has a substantially better collimatability with regard to the second direction, or with regard to the fast axis, one homogenizer stage for the fast axis proves to be sufficient as a rule. The use of one stage for the fast axis and two stages for the slow axis results in a substantially lower outlay on application than in the case of a completely two-stage homogenizer. The reason for this is that the spacing between the two homogenizers must be adjusted relative to one another only with regard to one axis, namely with regard to the slow axis. The spacing of the homogenizers can be optimally adapted in this way to the requirements with regard to the slow axis. Furthermore, there is a lowering of the requirements placed on the focal length tolerances of the lenses or the like used for the homogenizers.

It can be provided that the beam transforming means have a plurality of beam transforming elements arranged next to one another in the first direction. It can be provided here that the laser light emanating from one of the emitters impinges on more than one of the beam transforming elements. For example, the beam transforming elements can be designed here as cylindrical lenses whose cylinder axes are inclined at an angle of approximately 45° and/or −45° to the first direction.

There is also the possibility that the homogenizer means also have a plurality of homogenizer elements arranged next to one another in the first direction. The homogenizer elements can likewise be designed as cylindrical lenses here. There is a possibility that the center distance of the beam transforming elements relative to one another is not equal to the center distance of the homogenizer elements. The intensity distribution in the region of the surface to be illuminated can be homogeneously fashioned in this way.

It can be provided that the collimation means comprise fast-axis collimation means that serve to collimate the laser light emerging from the emitters with regard to the second direction. Furthermore, it can be provided that the collimation means have slow-axis collimation means that serve to collimate the laser light emerging from the emitters with regard to the first direction.

Furthermore, it can be provided that the spacing of the individual emitters from one another in the first direction is less than half, in particular less than one-tenth, of the extent of each of the emitters in the first direction. Furthermore, it can be provided that the semiconductor laser bar is designed as a QCW bar.

### BRIEF DESCRIPTION OF THE DRAWINGS

Further features and advantages of the present invention will become clear from the following description of preferred exemplary embodiments with reference to the attached figures, in which:

FIG. 1a shows a side view of an apparatus according to the invention;

FIG. 1b shows a side view, rotated by 90° with reference to FIG. 1a, of the apparatus according to the invention;

FIG. 2a shows a perspective view of the beam transforming means of the apparatus according to the invention;

FIG. 2b shows a schematic section of the line IIb-IIb in FIG. 2a;

FIG. 3 shows a perspective view of the beam transforming means with three exemplary beams;

FIG. 4a shows a detailed view of the laser diode bar, the fast-axis collimation means and the beam transforming means with exemplary component beams of the laser light; and

FIG. 4bshows a detailed view, rotated by 90° with reference to FIG. 4a, of the laser diode bar, the fast-axis collimation means and the beam transforming means with exemplary component beams of the laser light.

### DETAILED DESCRIPTION OF THE INVENTION

Cartesian coordinate systems have been drawn in the figures for the sake of better clarity.

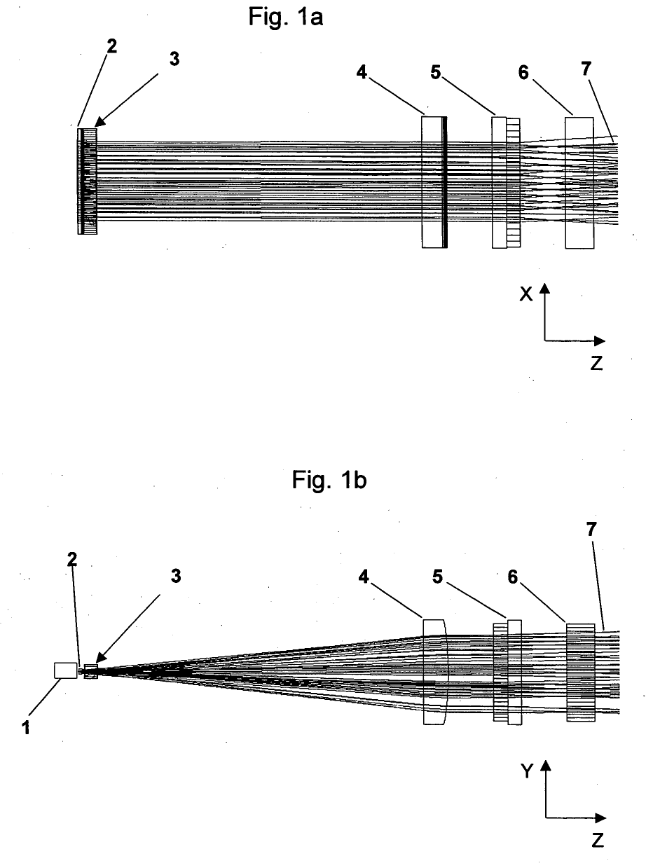

As is to be seen from FIG. 1a and FIG. 1b, an apparatus according to the invention includes a semiconductor laser bar 1 that is designed, in particular, as a so-called QCW bar. Like other semiconductor laser bars, a QCW bar also has a number of emitters arranged next to one another and spaced apart from one another in the X-direction. However, in the case of QCW bars, the spacing between the individual emitters is substantially smaller than the extent of the emitters in the X-direction.

Sixty emitters, for example, are arranged next to one another and at a spacing from one another in the X-direction, the so-called slow-axis direction, in the case of typical QCW bars. The size of the emitting surfaces of the emitters can in this case be approximately 1 μm in the Y-direction, the so-called fast-axis direction, and approximately 150 μm in the X-direction. Here, the spacing between individual emitters in the X-direction can be approximately 10 μm. This corresponds to a center distance (pitch) of approximately 160 μm.

Furthermore, QCW bars are distinguished by a very long pulse duration in conjunction with high repetition frequency, the result being a duty cycle of up to 20%. The duty cycle reproduces the percentage fraction of time segments in which the emitter emits laser light. Typical pulse durations of a QCW bar are 150 μs in conjunction with a repetition frequency of 1 kHz. Maximum pulse durations of the QCW bars are approximately 500 μs. These properties give QCW bars their name, which indicates a quasi-continuous operation of the semiconductor laser bar.

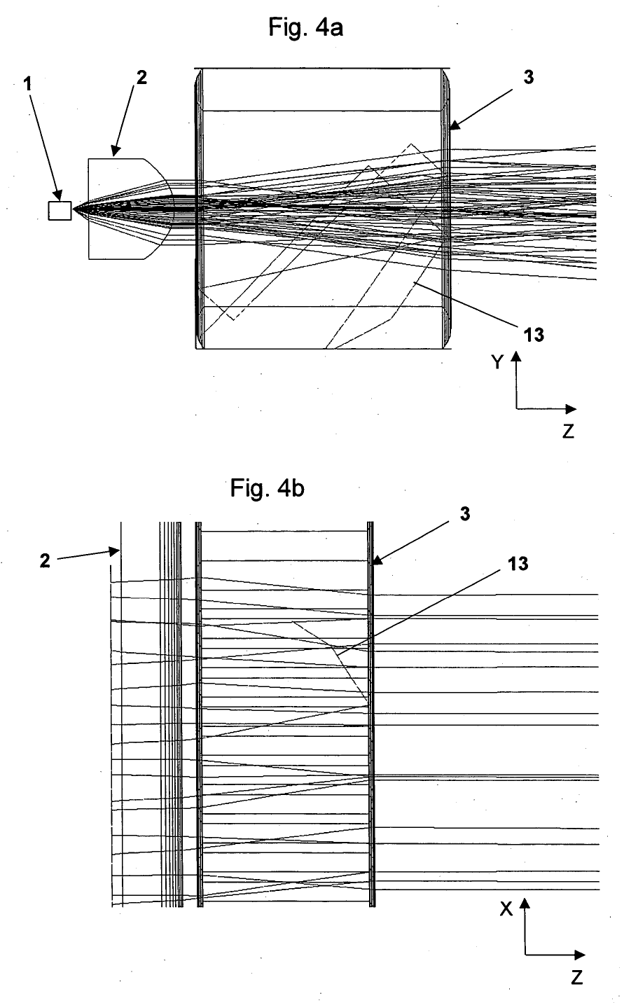

The semiconductor laser bar 1 is illustrated solely schematically by a rectangle in FIG. 1b and FIG. 4a.

It may be seen from FIG. 4a and FIG. 4bthat fast-axis collimation means 2 adjoin the semiconductor laser bar 1 in the direction of propagation Z of the laser light emerging from the individual emitters of the semiconductor laser bar 1. As is clearly to be seen from FIG. 4a and FIG. 4b, the fast-axis collimation means 2 are designed, for example, as a planoconvex cylindrical lens whose cylinder axis extends in the X-direction. Such a cylindrical lens can be used to collimate the laser light emerging from the individual emitters with regard to the Y-direction or with regard to the fast-axis in a fashion limiting diffraction. In order to achieve this, the cylindrical lens serving as fast-axis collimation means 2 can have an aspheric surface. Instead of the cylindrical lens illustrated, which has a convex curvature only on its exit side, it is also possible to use a cylindrical lens with a convexly curved entrance side. As an alternative to this, it is also possible to give both the entrance side and the exit side convex and/or concave curvatures.

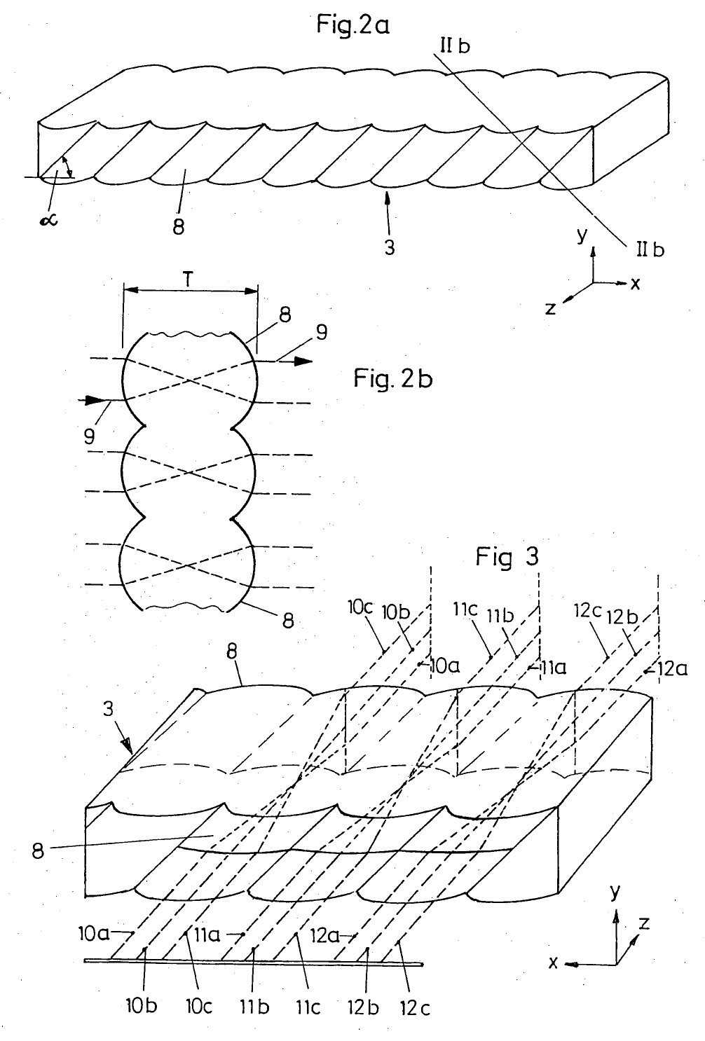

Adjoining the fast-axis collimation means 2 in the direction of propagation Z are beam transforming means 3 that may be seen in detail from FIG. 2a, FIG. 2b and FIG. 3 in particular. In the beam transforming means 3, the incident light is rotated by an angle of 90°, or the divergence of the fast-axis (Y-direction) is exchanged with that of the slow-axis (X-direction) such that the divergence in the Y-direction is approximately 160 mrad and the divergence in the X-direction is approximately 3 mrad after the exit from the apparatus 3.

Slow-axis collimation means 4 adjoin the beam transforming means 3 in the direction of propagation Z of the laser light such that it is possible to achieve a beam of 10 mm×10 mm with a divergence of approximately 11 mrad in the Y-direction, and a divergence of approximately 3 mrad in the X-direction. The numerical values of divergence and beam diameter relate to the full width of the beam at half the maximum intensity (FWHM). The slow-axis collimation means 4 are designed as a planoconvex cylindrical lens with a cylinder axis extending in the X-direction. Because of the rotation of the laser light in the beam transforming means 3, the slow-axis collimation means 4 therefore have the same alignment as the fast-axis collimation means 2. Just like the fast-axis collimation means 2, the slow-axis collimation means 4 can also be fashioned otherwise. In particular, both the entrance and exit surfaces can be provided with a convex and/or concave curvature.

Adjoining the slow-axis collimation means 4 in the direction of propagation Z are first homogenizer means 5 that are adjoined, in turn, by second homogenizer means 6. The homogenizer means 5 have on their entrance surface an array of cylindrical lenses whose cylinder axes extend in the X-direction. Furthermore, the first homogenizer means have on their exit surface an array of cylindrical lenses whose cylinder axis extend in the Y-direction. Owing to the cylindrical lens arrays, arranged crosswise with one another, on the entrance and exit surfaces of the first homogenizer means, the laser light passing through the first homogenizer means 5 is superposed very effectively on one another both in the slow-axis direction and in the fast-axis direction or both in the X-direction and in the Y-direction. A homogenization of the laser light can be achieved through this effective superposition, which is illustrated in FIG. 1a and FIG. 1b by the focus regions visible downstream of the first homogenizer means 5.

The apparatus includes second homogenizer means 6 in the direction of beam propagation Z downstream of the first homogenizer means. On their entrance and/or exit surfaces, these second homogenizer means 6 have a cylindrical lens array with cylindrical lenses that extend in Y-direction. The overall result is that the laser light is homogenized in two stages, the second stage acting only on the slow axis, and the first stage acting both on the slow axis and on the fast axis.

The reference numeral 7 denotes the laser light 7 that emerges from the apparatus according to the invention in a fashion collimated and homogenized as far as possible and which can be used to illuminate a surface remote from the apparatus.

An embodiment of the beam transforming means 3 may be seen from FIG. 2a and FIG. 2b. This is a substantially cuboid block made from a transparent material, on which a number of cylindrical lens segments serving as beam transforming elements 8 are arranged parallel to one another both on the entrance side and on the exit side. The axes of the beam transforming elements 8 enclose an angle a of 45° with the base side of the cuboid beam transforming means 3, which runs in the X-direction. Approximately ten cylindrical lens segments are arranged next to one another on each of the two X,Y-surfaces of the beam transforming means 3 in the exemplary embodiment illustrated. It is to be seen from FIG. 2b that the depth T, measured in the Z-direction, of the biconvex cylindrical lenses formed by the cylindrical lens array is equal to twice the focal length of each of these biconvex cylindrical lenses. This corresponds to
T=2Fₙ.

Here, T is the depth of the beam transforming means 3 designed as cylindrical lens array, and Fₙ is the focal length of each of the biconvex cylindrical lenses in conjunction with a refractive index n of the selected material of the beam transforming means 3. Visible from FIG. 2b is a schematic beam path of laser light 9 which illustrates that each of the biconvex cylindrical lenses changes a parallel light beam into a parallel light beam, in turn.

FIG. 3 shows the passage of a light beam impinging linearly on the beam transforming means 3 through the beam transforming means 3 with reference to the example of component beams 10a, b, c, 11a, b, c, 12a, b, c. Simplified, the component beams 10, 11, 12 are illustrated as if the light beam extends only in the X-direction. Furthermore, the component beams 10, 11, 12 are illustrated separately from one another, although the laser light 9 emanating from the individual emitters already overlaps before the entry into the beam transforming means. In accordance with the arrangement in FIG. 1a and FIG. 1b, the beam transforming means 3 are aligned such that the optically functional surfaces provided with the cylindrical lens segments are substantially X-Y-surfaces.

It is to be seen from FIG. 3 that upon passing through the beam transforming means 3 the component beams 10, 11, 12 experience a rotation by 90° such that after the passage through the beam transforming means 3 the individual component beams 10, 11, 12 in each case extend only in the Y-direction. For example, here the light beam 10b runs unimpeded through the beam transforming means 3, whereas the light beam 10a impinging to the left of it on the entrance surface is deflected toward the middle and downward, and the light beam 10c impinging to the right of it on the entrance surface is deflected toward the middle and upward. The same holds for the component beams 11 and 12.

Before their entrance into the beam transforming means 3, the component beams emerging from individual emitters overlap in the apparatus according to the invention. After the passage through the beam transforming means 3, only a residual divergence with limited diffraction is present in the X-direction, whereas the divergence in the Y-direction corresponds to the original divergence in the X-direction of, for example, approximately 160 mrad.

The beam path of the laser light through the fast-axis collimation means 2 and the beam transforming means 3 may be seen in FIG. 4a and FIG. 4b. Particularly because of the fact that the component beams emerging from individual emitters overlap before they enter into the beam transforming means 3, individual component beams 13 can impinge in transition regions between individual ones of the beam transforming elements 8 in such a way that they are scattered out of the laser light moving substantially in the Z-direction. These component beams are clearly to be seen in FIG. 4a and FIG. 4b. However, it turns out that the portion of the component beams scattered out of the laser light moving in the Z-direction because of the overlapping is relatively small, and so the maximum loss occurring in the beam transforming means 3 is approximately 5% of the irradiated power.

A further overlapping of the component beams emerging from the individual emitters is prevented because of the exchange of the divergences of the slow axis and fast axis in the beam transforming means 3. It is thereby possible for the spacing between the beam transforming means 3 and the slow-axis collimation means 4 to be selected to be very large so that the collimation by the slow-axis collimation means 4 can be performed at a very long focal length of the cylindrical lens used therefor. The result of this is a larger beam diameter in the Y-direction (see FIG. 1b in this regard) and, consequently, a smaller divergence because of the constant beam parameter product. It is possible to achieve in this way that, after subsequent homogenization by the homogenizer means 5, 6, the laser light can be used optimally for illuminating a remote surface.

What is claimed is:

1. An apparatus for illuminating a surface, comprising:
at least one semiconductor laser bar with a plurality of emitters that are arranged in a first direction (X) next to one another and at a spacing from one another,
the spacing of the individual emitters from one another being smaller than the extent of the emitters in the first direction (X),
and the divergence of the laser light emerging from the individual emitters being smaller with regard to the first direction (X) than the divergence of the laser light with regard to a second direction (Y) perpendicular to the first direction (X);
further comprising collimation means for the at least partial collimation of the laser light emerging from the emitters;
wherein
for the purpose of transforming the laser light emerging from the emitters, the illuminating apparatus has beam transforming means that are designed, and arranged in the beam path of the laser light emerging from the emitters, in such a way that they can exchange the divergence of the laser light with regard to the first direction (X) with the divergence with regard to the second direction (Y),
the beam transforming means having such a spacing from the laser diode bar that at least the laser light from two directly adjacent emitters overlaps with one another upon impinging on the beam transforming means in the first direction (X).

2. The apparatus for illuminating a surface as claimed in claim 1, wherein the illuminating apparatus comprises homogenizer means for homogenizing the laser light emerging from the emitters.

3. The apparatus for illuminating a surface as claimed in claim 2, wherein the homogenizer means are of multistage design.

4. The apparatus for illuminating a surface as claimed in claim 3, wherein the number of the stages of the homogenizer means for homogenizing with regard to the first direction (X) is greater than that for homogenizing with regard to the second direction (Y).

5. The apparatus for illuminating a surface as claimed in claim 1, wherein the beam transforming means have a plurality of beam transforming elements arranged next to one another in the first direction (X).

6. The apparatus for illuminating a surface as claimed in claim 5, wherein the laser light emanating from one of the emitters impinges on more than one of the beam transforming elements.

7. The apparatus for illuminating a surface as claimed in claim 5, wherein the beam transforming elements are designed as cylindrical lenses whose cylinder axes are inclined at an angle of approximately 45° and/or −45° to the first direction (X).

8. The apparatus as claimed in claim 1, wherein the homogenizer means have a plurality of homogenizer elements that are arranged next to one another in the first direction (X) and are cylindrical lenses.

9. The apparatus as claimed in claim 8, wherein the center distance of the beam transforming elements relative to one another is not equal to the center distance of the homogenization elements.

10. The apparatus as claimed in claim 1, wherein the collimation means comprise fast-axis collimation means that serve to collimate the laser light emerging from the emitters with regard to the second direction (Y).

11. The apparatus for illuminating a surface as claimed in claim 1, wherein the collimation means comprise slow-axis collimation means that serve to collimate the laser light emerging from the emitters with regard to the first direction (X).

12. The apparatus as claimed in claim 1, wherein the spacing of the individual emitters from one another in the first direction (X) is less than half, in particular less than one-tenth, of the extent of each of the emitters in the first direction (X).

13. The apparatus for illuminating a surface as claimed in claim 1, wherein the semiconductor laser bar is designed as a QCW bar.
